(19) United States
(12) Patent Application Publication
(10) Pub. No.: US 2017/0054693 A1
(43) Pub. Date: Feb. 23, 2017

(54) INTEGRITY VERIFICATION SYSTEM USING REMOTE CODE EXECUTION AND METHOD THEREOF

(71) Applicants: Ksign Co., Ltd., Seoul (KR); Soongsil University Research Consortium Techno-Park, Seoul (KR)

(72) Inventors: Jeong-Hyun Yi, Seongnam-si (KR); Yong-Jin Park, Seoul (KR); Sun-Woo Shin, Seoul (KR)

(73) Assignees: Ksign Co., Ltd., Seoul (KR); Soongsil University Research Consortium Techno-Park, Seoul (KR)

(21) Appl. No.: 15/205,342

(22) Filed: Jul. 8, 2016

(30) Foreign Application Priority Data
Aug. 19, 2015 (KR) 10-2015-0116678

(51) Int. Cl. H04L 29/06; G06F 21/60

(52) U.S. Cl. CPC H04L 63/0428; G06F 21/60; H04L 2209/16

(57) ABSTRACT

The integrity verification system includes a client and an RCE server. The client requests an RCE service to the RCE server using a pointer of a return function as a parameter of a service call function and transmits a memory code of the return function to the RCE server when Reverse-RCE for obtaining the memory code of the return function is requested from the RCE server. The RCE server generates a first hash key of the transmitted memory code, compares the first hash key to a stored second hash key of the memory code of an original return function, generates a return value according to a compared result between the first hash key and the second hash key and transmits the generated return value to the client using the generated return value as a parameter of the service call function. The client executes the return function using the return value as a parameter of the return function.

### PRIORITY STATEMENT

This application claims priority under 35 USC. §119 to Korean Patent Application No. 10-2015-0116678, filed on Aug. 19, 2015 in the Korean Intellectual Property Office (KIPO) the contents of which are herein incorporated by reference in their entireties.

### BACKGROUND

1. Technical Field

Exemplary embodiments relate to an integrity verification system using remote code execution and a method of verifying integrity using the integrity verification system. More particularly, exemplary embodiments relate to an integrity verification system preventing a secret code of a mobile application from being exposed using remote code execution and verifying integrity of the mobile application and a method of verifying integrity using the integrity verification system.

2. Description of the Related Art

According to a report of Gartner Inc., which is an IT research group, in a first quarter in 2014, shipments of a smart tablet and a smart phone in 2014 is predicted to be two billion, which is increased by 11% from the shipments in 2013 and shipments of the smart tablet and the smart phone in 2015 is predicted. to exceed 2.3 billion. Accordingly, users of mobile applications of Android Google Play may increase and demand on technology to protecting the mobile application may increase.

Generally, the mobile application is vulnerable to attack based on reverse engineering due to a technological characteristic of the mobile application. Thus, a security method such as obfuscation has been employed to improve resistivity of the reverse engineering. However, although the conventional security method such as the obfuscation is employed to the mobile application, the mobile application may be attacked by repackaging, which changes a program logic by modulating a program comparing routine or an execution result and redistributes the changed program logic. Thus, the resistivity of the reverse engineering of the mobile application may not be sufficient by the conventional security method,

When the mobile application is attacked by repackaging, the program logic or a return value may he changed. A technical development may be needed to solve this problem.

The technical art relating the above-mentioned issue is disclosed in Korean Patent Application Publication No. 10-2014-0082408 which is published on Jul. 2, 2014.

### SUMMARY

Exemplary embodiments provide an integrity verification system preventing a secret code of a mobile application from being exposed using remote code execution and verifying integrity of the mobile application to improve resistivity of reverse engineering and a method of verifying integrity using the integrity verification system.

In an exemplary integrity verification system using remote code execution (“RCE”) according to the present inventive concept, the integrity verification system includes a client and an RCE server. The client is configured to request an RCE service to the RCE server using a pointer of a return function as a parameter of a service call function and configured to transmit a memory code of the return function to the RCE server when Reverse-RCE for obtaining the memory code of the return function is requested from the RCE server. The RCE server is configured to generate a first hash key of the transmitted memory code, configured to compare the first hash key to a stored second hash key of the memory code of an original return function, configured to generate a return value according to a compared result between the first hash key and the second hash key and configured to transmit the generated return value to the client using the generated return value as a parameter of the service call function. The client is configured to execute the return function using the return value as a parameter of the return function.

In an exemplary embodiment, the client may he configured to transmit the memory code of the return function loaded in a memory to the RCE server.

In an exemplary embodiment, the client may be configured to dump the memory code of the return function and to transmit the memory code of the return function. The RCE server may be configured to bash binary values of the transmitted memory code to generate the first hash value.

In an exemplary embodiment, the RCE server may be configured to store the second hash value which is generated by hashing binary values of the memory code of the original return function.

In an exemplary embodiment, when the first bash value is same as the second bash value, the RCE server may be configured to determine the integrity of the memory code to be verified and configured to transmit the return value to the client by the Reverse-RCE.

In an exemplary method of verifying integrity using remote code execution (“RCE”) according to the present inventive concept, the method includes requesting, by a client, an RCE service to an RCE server using a pointer of a return function as a parameter of a service call function, requesting, by the RCE server, a memory code of the return function to the client using the pointer of the return function by Reverse-RCE, generating, by the RCE server, a first bash key of the memory code transmitted from the client, comparing, by the RCE server, the first hash key to a stored second hash key of the memory code of an original return function, generating, by the RCE server, a return value according to a compared result between, the first hash key and the second hash key, transmitting, by the RCE server, the generated return value to the client using the generated return value as a parameter of the service call function and executing, by the client, the return function using the return value as a parameter of the return function.

According to the integrity verification system using remote code execution and the method of verifying integrity using the integrity verification system, the secret code of the mobile application is prevented, from being exposed using the remote code execution based on the remote code execution communication technology so that the code may be presented from being changed from a remote place, the integrity may be obtained and the resistibility of the reverse engineering may be improved.

### BRIEF DESCRIPTION OF THE DRAWINGS

The above and other features and advantages of the present inventive concept will become more apparent by describing in detailed exemplary embodiments thereof with reference to the accompanying drawings, in which:

FIG. 1 is a block diagram illustrating an integrity verification system using remote code execution according to an exemplary embodiment of the present inventive concept;

FIG. 2 is a conceptual diagram illustrating initialization of the integrity verification system according to an exemplary embodiment of the present inventive concept;

FIG. 3 is a detailed block diagram illustrating a client and an RCE server;

FIG. 4 is a conceptual diagram illustrating a service flow of the integrity verification system according to an exemplary embodiment of the present inventive concept;

FIG. 5 is a flowchart illustrating a method of verifying integrity using the remote code execution according to an exemplary embodiment of the present inventive concept; and

FIG. 6 is a conceptual diagram illustrating the method of FIG. 5.

### DETAILED DESCRIPTION OF THE EMBODIMENTS

The integrity verification system using the remote code execution and the method of verifying integrity of the present inventive concept now will be described more hilly hereinafter with reference to the accompanying drawings, in which exemplary embodiments of the present inventive concept are shown. The present inventive concept may, however, be embodied in many different forms and should not be construed as limited to the exemplary embodiments set fourth herein. In the accompanying drawings, widths of lines or sizes of elements may be exaggerated for convenience of explanation.

The terms used herein are defined considering functions in the present inventive concept. Interpretation of the terms may vary according to intention of a user or convention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Generally, remote code execution (“RCE”) service may operated using a client (or caller) calling an RCE code and an RCE server providing the RCE service.

In the present inventive concept, the remote code execution based on the RCE service is applied to the mobile application which is vulnerable to attack based on reverse engineering. Thus, according to the integrity verification system using the remote code execution of the present inventive concept, the secret code of the mobile application is prevented from being exposed and the integrity may be obtained.

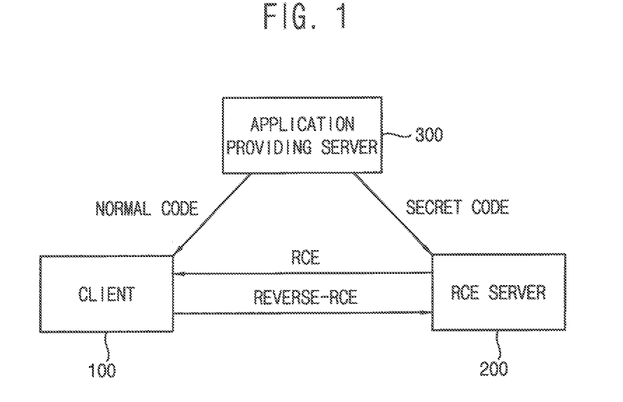

Hereinafter, the integrity verification system using the remote code execution according to an exemplary embodiment of the present inventive concept is explained referring to FIGS. 1 to 4.

FIG. 1 is a block diagram illustrating an integrity verification system using remote code execution according to an exemplary embodiment of the present inventive concept.

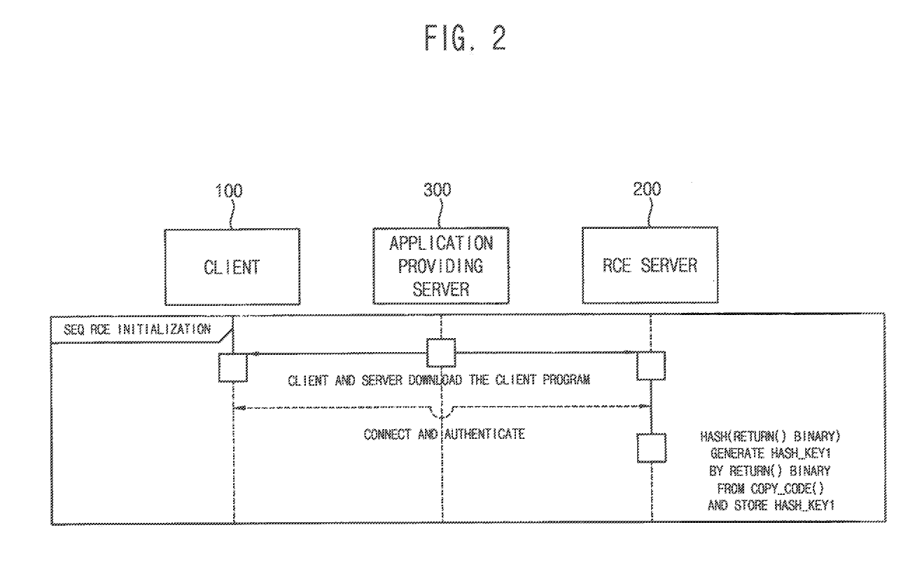

FIG. 2 is a conceptual diagram illustrating initialization of the integrity verification system according to an exemplary embodiment of the present inventive concept.

Referring to FIGS. 1 and 2, the integrity verification system using the remote code execution includes a client 100, an RCE server 200 and an application providing server 300.

The application providing server 300 divides an application file into a normal code and a secret code. The divided normal code and the secret code are respectively transmitted to the client 100 and the RCE server 200.

The application providing server 300 may set the secret code using the executable file decompiled from an application package. The application providing server 300 generates the normal code by removing the secret code from the application file. Both of the normal code and the secret code may be installed to the client 100 and the RCE server 200 and may have a file type capable of being executed ha the client 100 and the RCE server 200.

The secret code may be a code required to be protected from an attack in a user's viewpoint. The secret code may be generated by restructuring the code required to be protected in C code. The secret code may be stored in Executable and Linkable Format (“ELF”). The structure of the ELF is not explicitly analyzed compared to the structure of DEX (Dalvik Executable) format so that the secret code may not be easily exposed by dynamic analysis and static analysis for forgery of the code. In addition, command structures in the ELF include CPU commands having a level lower than the level of the commands of Dalvik so that the resistibility of the dynamic analysis and the static analysis may increase.

For example, the application providing server 300 may store the normal code and the secret code of various applications related to finance, news, shopping, game and so on. The client 100 and the RCE server 200 may download the normal code and the secret code from the application providing server 300 and install the normal code and the secret code. Herein, the application providing server 300 may be a mobile application market. For example, the mobile application market may be Google Play or Apple App Store.

A return function of the normal code generated by the application providing server 300 is stored in the client 100. An original return function of the secret code is stored in the RCE server 200 in a remote place, The RCE server 200 hashes binary values of a memory code of the original return function, generates a hash key and stores the hash key as shown in FIG. 2.

After the above-mentioned initialization step, the client 100 of the present exemplary embodiment requests an RCE service to the RCE server 200 using a pointer of the return function as a parameter of a service calling function. When the Reverse-RCE is requested by the RCE server 200 to receive the memory code of the return function, the client 100 transmits the memory code of the return function to the RCE server 200.

The client 100 dumps the memory code of the return function which is loaded in a memory and transmits the memory code to the RCE server 200.

In addition, When the client 100 receives a return value generated by executing a service function as a parameter of the service call function from the RCE server, the client 100 executes the return function using the return value as a parameter of the return function. The service call function of the client 100 may confirm a result of the execution of the return function.

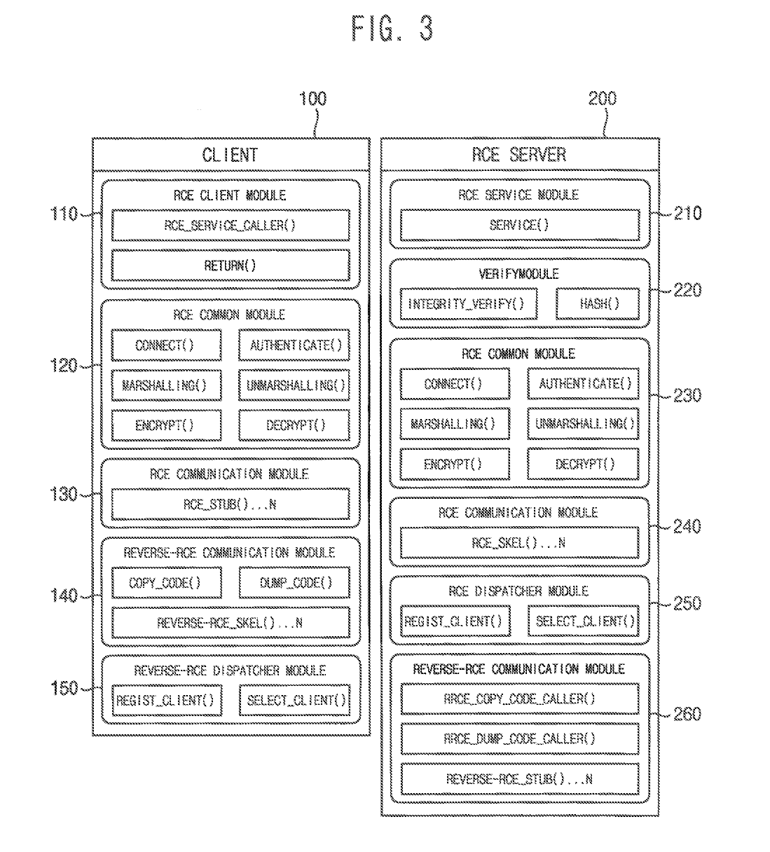

FIG. 3 is a detailed block diagram illustrating the client and the RCE server.

As shown in FIG. 3, the client 100 includes following modules.

An RCE client module 110 requests the RCE service to the RCE server 200. An RCE common module 120 operates a common operation (connect, authenticate, encrypt/decrypt, marshalling, unmarshalling) used in the RCE and the Reverse-RCE. An RCE communication module 130 includes stubs which are objects operated instead of remote objects for the RCE communication. A Reverse-RCE communication module 140 transmits skels (skeletons) and the return function for the Reverse-RCE communication. A Reverse-RCE dispatcher module 150 registers services of the Reverse-RCE and connects the service requests. When the service request is connected to the RCE service, an execution process obfuscating method may be applied to increase complexity of call process.

When the RCE server 200 receives the RCE request using the pointer of the return function as the parameter of the service call function from the client 100, the RCE server 200 requests the Reverse-RCE to transmit the memory code of the return function to the client 100. When the RCE server 200 receives the memory code from the client 100, the RCE server 200 generates the hash key of the received memory code.

The RCE server 200 hashes the binary values of the memory code transmitted from the client 100 to generate the hash key.

The RCE server 200 compares the hash key generated by hashing the binary values of the memory code transmitted from the client 100 to the stored hash key of the memory code of the original return function generated in the initialization step. When the generated hash key is the same as the stored hash key, the integrity of the memory code of the return value is determined to be verified and the service function is executed to generate the return value (execution result). The RCE server 200 transmits the generated return value to the client 100 by the Reverse-RCE using the generated return value as the parameter of the service call function.

As shown in FIG. 3, the RCE server 200 includes following modules.

An RCE service module 210 includes service operations requested by the RCE, verifying module (Verifymodule) 220 verifies the hash value of the return function. An RCE common module 230 operates a common operation (connect, authenticate, encrypt/decrypt, marshalling, unmarshalling) used in the RCE and the Reverse-RCE. An RCE communication module 240 includes skels (skeletons) which are objects operated instead of remote objects for the RCE communication. An RCE dispatcher module 250 registers services of the RCE and connects the service requests. When the service request is connected to the RCE service, an execution process obfuscating method may be applied to increase complexity of call process. In addition, the Reverse-RCE communication module 250 receives stabs and the return function for the Reverse-RCE communication.

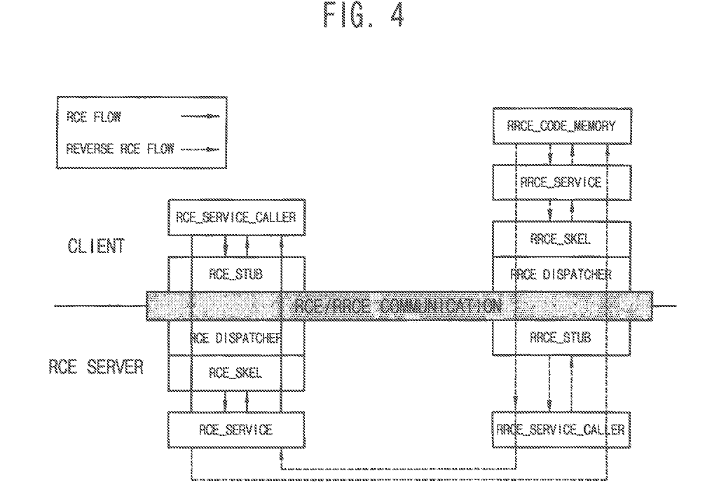

FIG. 4 is a conceptual diagram illustrating a service flow of the integrity verification system according to an exemplary embodiment of the present inventive concept.

In FIG. 4, an above portion with respect to RCE/RRCE Communication line represents the client 100 and a below portion with respect to the RCE/RRCE Communication line represents the RCE server.

To verify the integrity, a service execution flow starts from RCE_Service Caller of the client 100, the flow goes to the RCE_Service of the RCE server 200, the flow goes to the RRCE_Service_Caller and the flow goes to the RRCE_Service of the client and the flow accesses to the RRCE_Code_Memory (the return function code in the memory). The flow returns back to the RCE_Service_Caller of the client 100 from the RRCE_Code_Memory via RRCE_Service_Caller and RCE_Service.

The RCE communication and the Reverse_RCE communication respectively use RCE_Stub/RCE_Skel and RRCE_Stub/RRCE_Skel. Each Skel registers and selects the service using the RCE_Dispatcher and the RRCE_Dispatcher.

Hereinafter, a method of verifying integrity operated by the integrity verification system using the remote code execution according to the present exemplary embodiment is explained.

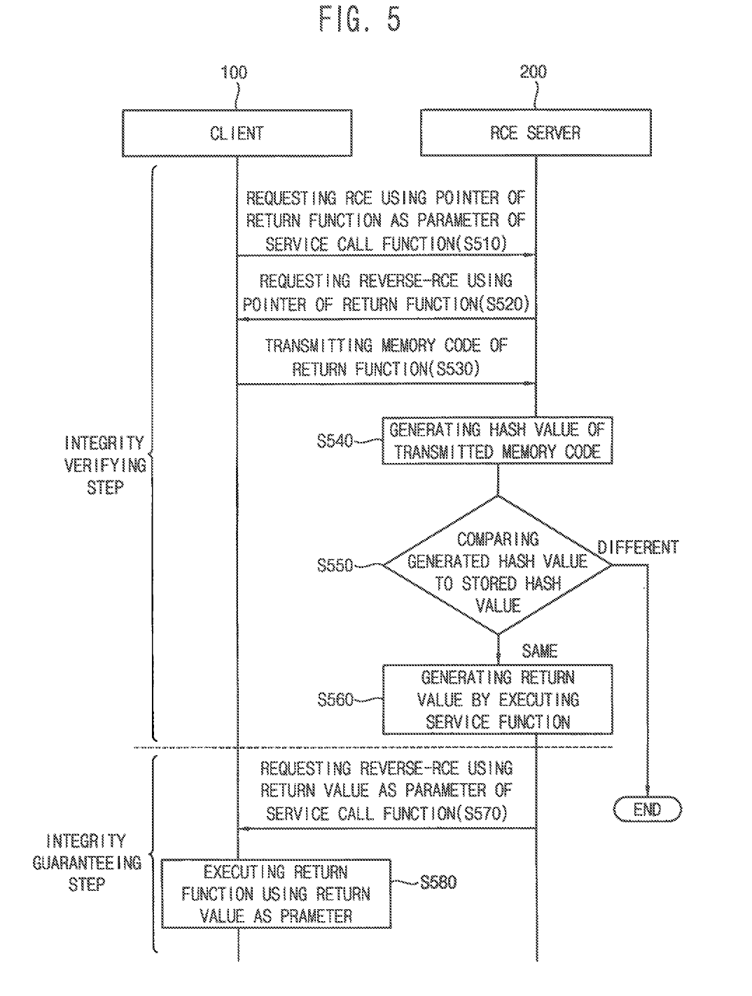

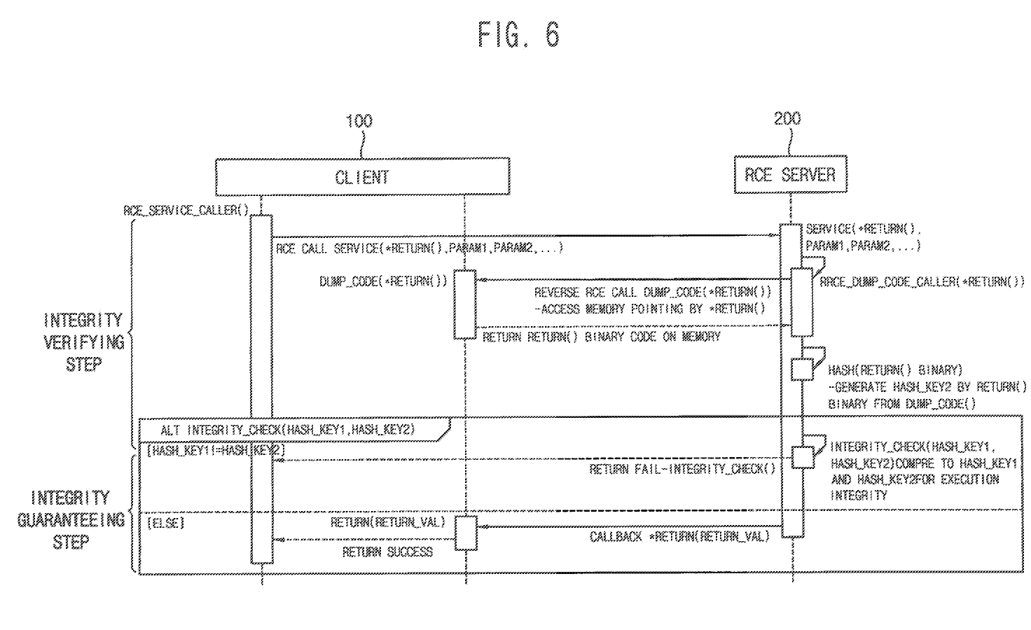

FIG. 5 is a flowchart illustrating a method of verifying integrity using the remote code execution according to an exemplary embodiment of the present inventive concept and FIG. 6 is a conceptual diagram illustrating the method of FIG. 5.

According to the method of verifying integrity using the remote code execution, the client 100 requests the RCE service using the pointer of the return function as the parameter of the service call function (e.g. RCE CALL SERVICE( ) in FIG. 6) to the RCE server 200 (step S510).

When the RCE server 200 receives the RCE service request, the RCE server 200 requests the memory code of the return function using the pointer of the return function received from the client 100 (e.g. Reverse RCE call DUMP_CODE( ) in FIG. 6) (step S520).

The client 100 transmits the memory code of the return function of the RCE server 200 (step S530).

The client 100 dumps the memory code of the return function loaded in the memory and transmits the dumped memory code to the RCE server 200.

Then, the RCE server 200 generates the hash key of the memory code transmitted from the client 100 in the step S530 (step S540).

For example, the RCE server 200 generates the hash key by hashing the binary value of the memory code transmitted from the client 100 (e.g. HASH( ) in FIG. 6).

Then, the RCE server 200 compares the generated hash key in the step S540 and the stored hash key of the memory code of the original return function (step S550).

In the step 550, whether the return function loaded in the memory of the client 100 is changed or not is verified using INTEGRITY_CHECK( ) in FIG. 6.

When the generated hash key in the step S540 is the same as the stored hash key as a result of the step S550, the integrity of the memory code of the return function is determined to be verified and the service function is executed to generate the return value (execution result) (step S560).

The generated return value in the step S560 is transmitted to the client 100 by Reverse-RCE using the return value as the parameter of the service call function (e.g. CALLBACK*RETURN( )) (step S570).

In the step S570, by the Reverse-RCE call, the return value generated by the execution of the service function of the RCE server 200 is directly processed by the return inaction of the client 100 without change of a memo code of the client or change of the return value so that the return value is correctly applied to the service call function.

The client 100 processes the return function using the transmitted return value in the step S570 as the parameter (step S580).

The service call function of the client 100 may confirm a result of the execution of the return function.

Thus, the steps S510 to S560 in FIG. 5 may be included in the integrity verifying step. The steps S570 and S580 in FIG. 5 may be included in the integrity guaranteeing step.

The client 100 receives the return value from the service of the RCE server 200 using return function. The return function is called by the Reverse-RCE method. The retain value of the return. function is directly inputted from the RCE server 200 to the client 100.

Thus, according to the method of verifying the integrity of the present exemplary embodiment, the code of the return function is verified not to be changed (integrity). In addition, the return value is inputted the integrity-verified return function so that the integrity of the execution may be guaranteed.

According to the above-explained present exemplary embodiment, in the integrity verification system using remote code execution and the method of verifying integrity using the integrity verification system, the secret code of the mobile application is prevented from being exposed using the remote code execution based on the remote code execution communication technology so that the code may be presented from being changed from a remote place, the integrity may be obtained and the resistibility of the reverse engineering may be improved.

The foregoing is illustrative of the present inventive concept and is not to be construed as limiting thereof. Although a few exemplary embodiments of the present inventive concept have been described, those skilled in the art will readily appreciate that many modifications are possible in the exemplary embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited, to the specific exemplary embodiments disclosed, and that modifications to the disclosed exemplary embodiments, as well as other exemplary embodiments, are intended to be included within the scope of the appended claims. The present inventive concept is defined by the following claims, with equivalents of the claims to be included therein.

What is claimed is:

1. An integrity verification system using remote code execution (“RCE”), the integrity verification system comprising:
a client configured to request an RCE service to an RCE server using a pointer of a return function as a parameter of a service call function and configured to transmit a memory code of the return function to the RCE server when Reverse-RCE fur obtaining the memory code of the return function is requested from the RCE server; and
the RCE server configured to generate a first hash key of the transmitted memory code, configured to compare the first hash key to a stored second bash key of the memory code of an original return function, configured to generate a return value according to a compared result between the first hash key and the second hash key and configured to transmit the generated return value to the client using the generated return value as a parameter of the service call function,
wherein the client is configured to execute the return function using the return value as a parameter of the return function.

2. The integrity verification system of claim 1, wherein the client is configured to transmit the memory code of the return function loaded in a memory to the RCE server.

3. The integrity verification system of claim 1, wherein the client is configured to dump the memory code of the return function and to transmit the dumped memory code of the return function, and
the RCE server is configured to hash binary values of the transmitted memory code to generate the first hash value.

4. The integrity verification system of claim 1, wherein the RCE server is configured to store the second hash value which is generated by hashing binary values of the memory code of the original retain function.

5. The integrity verification system of claim 1, wherein when the first hash value is same as the second hash value, the RCE server is configured to determine the integrity of the memory code to be verified and configured to transmit the return value to the client by the Reverse-RCE.

6. A method of verifying integrity using remote code execution (“RCE”), the method comprising:
requesting, by a client, an RCE service to an RCE server using a pointer of a return function as a parameter of a service call function;
requesting, by the RCE server, a memory code of the return function to the client using the pointer of the return function by Reverse-RCE;
generating, by the RCE server, a first hash key of the memory code transmitted from the client;
comparing, by the RCE server, the first hash key to a stored second hash key of the memory code of an original return function;
generating, by the RCE server, a return value according to a compared result between the first hash key and the second hash key;
transmitting, by the RCE server, the generated return value to the client using the generated return value as a parameter of the service call function; and
executing, by the client, the return function using the return value as a parameter of the return function.

7. The method of claim 6, wherein in the requesting, by the RCE server, the memory code of the return function, the RCE server requests the memory code of the return function loaded in a memory of the client.

8. The method of claim 6, wherein the client dumps the memory code of the return function and transmits the dumped memory code to the RCE server, and
wherein the RCE server hashes binary values of the transmitted memory code to generate the first hash value.

9. method of claim 6, wherein the RCE server stores the second hash value which is generated by hashing binary values of the memory code of the original return function.

10. The method of claim 6, wherein when the first hash value is same as the second hash value, the RCE server determines the integrity of the memory code to be verified and transmits the return value to the client by the Reverse-RCE.
